(19) United States
(12) Patent Application Publication
(10) Pub. No.: US 2025/0249831 A1
(43) Pub. Date: Aug. 7, 2025

(54) METHOD AND APPARATUS FOR ADDRESSING CMS FAULT CONDITIONS

(71) Applicant: Stoneridge Electronics AB, Solna (SE)

(72) Inventors: In-Soo SUH, Beverly Hills, MI (US); Huimin Mattmuller, Rochester Hills, MI (US); Troy Otis Cooprider, White Lake, MI (US)

(21) Appl. No.: 18/429,658

(22) Filed: Feb. 1, 2024

(51) Int. Cl. B60R 1/27; B60R 11/00; B60R 11/02; B60R 11/04

(52) U.S. Cl. CPC B60R 1/27; B60R 11/0235; B60R 11/04; B60R 2011/0005; B60R 2011/0033; B60R 2300/301; B60R 2300/70

(57) ABSTRACT

A method for a CMS includes obtaining, at a CMS ECU, images of an environment surrounding a commercial vehicle from a first CMS camera and a second CMS camera disposed on opposing sides of the commercial vehicle. The method also includes displaying a first image feed from the first CMS camera on a first CMS display; displaying a second image feed from the second CMS camera on a second CMS display that is separate from the first CMS display; and based on detection of a fault condition in which the CMS ECU stops receiving the first image feed from the first CMS camera, performing a remedial action. The remedial action includes replacing the first image feed on the first CMS display with an image feed from a backup camera that is separate from the first CMS camera and the second CMS camera; displaying an image feed from the backup camera on a backup camera display while the commercial vehicle is moving forward; or adjusting a warning threshold for at least one object detection sensor, which comprises a radar sensor, lidar sensor, or ultrasonic sensor. Additional methods and CMSs are also disclosed.

### TECHNICAL FIELD

This disclosure relates to a camera monitor system (CMS), and more particularly to a method and apparatus for addressing CMS fault conditions.

### BACKGROUND

Vehicle camera systems for mirror replacement or for supplementing mirror views are utilized in commercial vehicles to enhance the ability of a vehicle operator to see a surrounding environment. Camera monitor systems (CMS) utilize one or more cameras to provide an enhanced field of view to a vehicle operator. In some examples, the mirror replacement systems cover a larger field of view than a conventional mirror, or include views that are not fully obtainable via a conventional mirror.

A CMS can be very useful to a driver when operating properly, however if a fault condition occurs this may present challenges for a driver that is accustomed to relying on the CMS for navigation.

### SUMMARY

A method for a camera monitor system (CMS) according to an example embodiment of the present disclosure includes obtaining, at a CMS electronic control unit (ECU), images of an environment surrounding a commercial vehicle from a first CMS camera and a second CMS camera. The first CMS camera and the second CMS camera are disposed on opposing sides of the commercial vehicle. The method also includes displaying a first image feed from the first CMS camera on a first CMS display; displaying a second image feed from the second CMS camera on a second CMS display that is separate from the first CMS display; and based on detection of a fault condition in which the CMS ECU stops receiving the first image feed from the first CMS camera, performing a remedial action. The remedial action includes replacing the first image feed on the first CMS display with an image feed from a backup camera that is separate from the first CMS camera and the second CMS camera; displaying an image feed from the backup camera on a backup camera display while the commercial vehicle is moving forward (where the backup camera display is separate from the first CMS display and the second CMS display); or adjusting a warning threshold for at least one object detection sensor, which includes a radar sensor, lidar sensor, or ultrasonic sensor.

In a further embodiment of the foregoing embodiment, the remedial action includes replacing the first image feed on the first CMS display with the image feed from the backup camera.

In a further embodiment of any of the foregoing embodiments, the remedial action includes displaying the image feed from the backup camera on the backup camera display while the commercial vehicle is moving forward.

In a further embodiment of any of the foregoing embodiments, the remedial action includes adjusting the warning threshold for the at least one object detection sensor.

A method for a camera monitor system (CMS) according to an example embodiment of the present disclosure includes obtaining, at a CMS electronic control unit (ECU), images of an environment surrounding a commercial vehicle from a first CMS camera and a second CMS camera. The first CMS camera and second CMS camera are disposed on opposing sides of the commercial vehicle. The method also includes displaying a first image feed from the first CMS camera on a first CMS display; displaying a second image feed from the second CMS camera on a second CMS display that is separate from the first CMS display; and based on detection of a fault condition in which the first CMS display cannot display the first image feed, initiating display of the first image feed on the second CMS display or a third display that is separate from the first CMS display and the second CMS display.

In a further embodiment of the foregoing embodiment, said initiating display includes initiating display of the first image feed on the third display.

In a further embodiment of any of the foregoing embodiments, the third display is an instrument cluster display of the commercial vehicle or a backup camera display of the commercial vehicle.

In a further embodiment of any of the foregoing embodiments, said initiating display of the first image feed includes initiating display of the first image feed on the second CMS display, such that the second CMS display displays the first image feed and the second image feed.

A method for a camera monitor system (CMS) according to an example embodiment of the present disclosure includes obtaining, at a CMS electronic control unit (ECU), images of an environment surrounding a commercial vehicle from a first CMS camera and a second CMS camera. The first CMS camera and second CMS camera are disposed on opposing sides of the commercial vehicle. The method also includes displaying a first image feed from the first CMS camera on a first CMS display, displaying a second image feed from the second CMS camera on a second CMS display, and based on detection of a fault condition of the CMS ECU, performing a remedial action. The remedial action includes displaying an image feed from a backup camera on a backup camera display while the commercial vehicle is moving forward (where the backup camera display is separate from the first CMS display and the second CMS display) or adjusting a warning threshold for at least one object detection sensor, which includes a radar sensor, lidar sensor, or ultrasonic sensor.

In a further embodiment of the foregoing embodiment, the remedial action includes displaying the image feed from the backup camera on the backup camera display while the commercial vehicle is moving forward.

In a further embodiment of any of the foregoing embodiments, the remedial action includes adjusting a warning threshold for the at least one object detection sensor.

A camera monitor system (CMS) according to an example embodiment of the present disclosure includes a first CMS camera, a second CMS camera, a first CMS display, a second CMS display, and a CMS electronic control unit (ECU). The CMS ECU is configured to obtain a first image feed from the first CMS camera and obtain a second image feed from the second CMS camera that both depict an environment surrounding a commercial vehicle. The ECU is configured to display the first image feed on the first CMS display and display the second image feed on the second CMS display, and based on detection of a fault condition in which the CMS ECU stops receiving the first image feed from the first CMS camera, perform a remedial action. The remedial action includes replacement of the first image feed on the first CMS display with an image feed from a backup camera that is separate from the first CMS camera and the second CMS camera; display of an image feed from the backup camera on a backup camera display while the commercial vehicle is moving forward (where the backup camera display is separate from the first CMS display and the second CMS display); or adjustment of a warning threshold for at least one object detection sensor, which includes a radar sensor, lidar sensor, or ultrasonic sensor.

In a further embodiment of the foregoing embodiment, the remedial action includes replacement of the first image feed on the first CMS display with the image feed from the backup camera.

In a further embodiment of any of the foregoing embodiments, the remedial action includes display of the image feed from the backup camera on the backup camera display while the commercial vehicle is moving forward.

In a further embodiment of any of the foregoing embodiments, the remedial action includes adjustment of the warning threshold for the at least one object detection sensor.

A camera monitor system (CMS) according to an example embodiment of the present disclosure includes a first CMS camera, a second CMS camera, a first CMS display, a second CMS display, and a CMS electronic control unit (ECU). The CMS ECU is configured to obtain images of an environment surrounding a commercial vehicle from the first CMS camera and the second CMS camera. The first CMS camera and second CMS camera are disposed on opposing sides of the commercial vehicle. The ECU is also configured to display a first image feed from the first CMS camera on the first CMS display; display a second image feed from the second CMS camera on the second CMS display; and based on detection of a fault condition in which the first CMS display cannot display the first image feed, initiate display of the first image feed on the second CMS display or on a third display that is separate from the first CMS display and the second CMS display.

In a further embodiment of the foregoing embodiment, the CMS ECU is configured to, based on detection of the fault condition of the first display, initiate display of the first image feed on the third display.

In a further embodiment of any of the foregoing embodiments, the third display is an instrument cluster display of the commercial vehicle or a backup camera display of the commercial vehicle.

In a further embodiment of any of the foregoing embodiments, the CMS ECU is configured to, based on detection of the fault condition of the first display, initiate display of the first image feed on the second CMS display, such that the second CMS display displays the first image feed and the second image feed.

A camera monitor system (CMS) according to an example embodiment of the present disclosure includes a first CMS camera, a second CMS camera, a first CMS display, a second CMS display, and a CMS electronic control unit (ECU). The CMS ECU is configured to obtain images of an environment surrounding a commercial vehicle from the first CMS camera and the second CMS camera. The first CMS camera and second CMS camera are disposed on opposing sides of the commercial vehicle. The ECU is also configured to display a first image feed from the first CMS camera on the first CMS display, display a second image feed from the second CMS camera on the second CMS display, and based on detection of a fault condition of the CMS ECU, perform a remedial action. The remedial action includes display of an image feed from a backup camera on a backup camera display while the commercial vehicle is moving forward (where the backup camera is separate from the first CMS camera and the second CMS camera) or adjustment of a warning threshold for at least one object detection sensor, which includes a radar sensor, lidar sensor, or ultrasonic sensor.

In a further embodiment of the foregoing embodiment, the remedial action includes display of the image feed from the backup camera on the backup camera display while the commercial vehicle is moving forward.

In a further embodiment of any of the foregoing embodiments, the remedial action includes adjustment of the warning threshold for the at least one object detection sensor.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The disclosure can be further understood by reference to the following detailed description when considered in connection with the accompanying drawings wherein:

FIG. 1 is a schematic front view of a commercial truck with a camera mirror system (CMS) used to provide at least Class II and Class IV views.

FIG. 2 is a schematic birds-eye view of the commercial truck of FIG. 1 with a CMS providing Class II, Class IV, Class V and Class VI views.

FIG. 3 is a schematic top view of an example vehicle cabin.

FIG. 4 is a perspective view of the vehicle cabin of FIG. 3.

FIG. 5A is a schematic view of a first electronic display from FIGS. 1-2.

FIG. 5B is a schematic view of a first electronic display from FIGS. 1-2.

FIG. 6 is a schematic view of example object detection sensors having associated object detection areas.

FIG. 7 is a schematic view of various CMS and advanced driver-assistance system (ADAS) elements that may be used for the commercial vehicle of FIG. 1.

FIG. 8 is a flowchart of an example method for a CMS.

### DETAILED DESCRIPTION

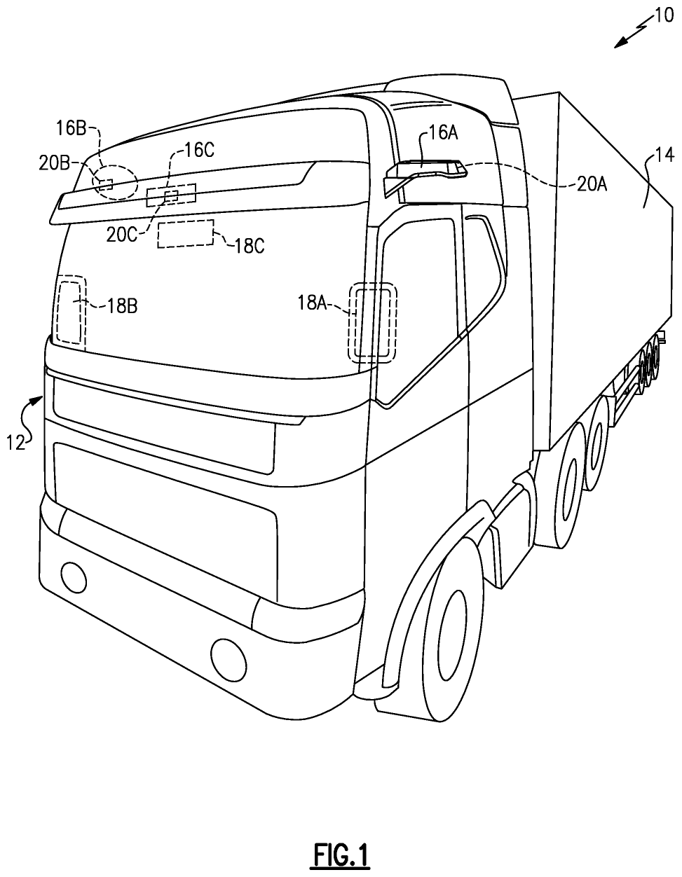

Schematic views of a commercial vehicle 10 are illustrated in FIGS. 1-4, 1B, 1C, and 1D. The commercial vehicle 10 includes a vehicle cab or “tractor” 12 for pulling a trailer 14, where the trailer 14 pivots with respect to the tractor 12 during turns. Although the commercial vehicle 10 is depicted as a commercial truck with a single trailer in this disclosure, it is understood that other commercial vehicle configurations may be used (e.g., different types or quantities of trailers).

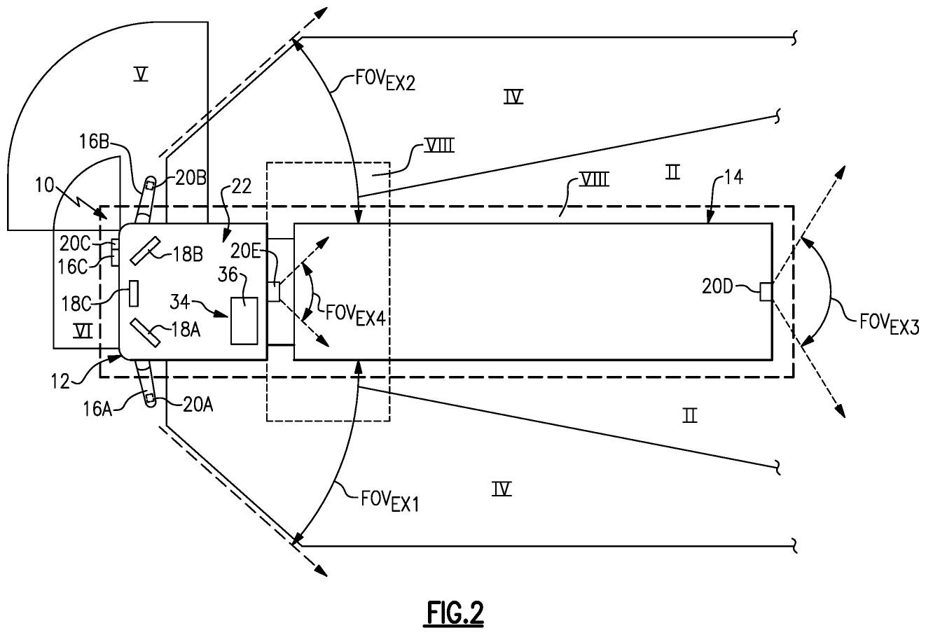

A pair of camera arms 16A-B include a respective base that is secured to, for example, the cab 12. A pivoting arm is supported by the base and may articulate relative thereto. At least one rearward facing camera 20A-B (generally, camera 20) is arranged respectively within the camera arms 16A-B. The exterior cameras 20A-B respectively provide an exterior field of view FOVEX1, FOVEx2 that each include at least one of Class II and Class IV views (FIG. 2), which are legal prescribed views in the commercial trucking industry.

The Class II view on a given side of the commercial vehicle 10 is a subset of the class IV view of the same side of the commercial vehicle 10. Multiple cameras also may be used in each camera arm 16A-B to provide these views, if desired. Class II (narrow) and Class IV (wide angle) views are defined in European R46 legislation, for example, and the United States and other countries have similar drive visibility requirements for commercial trucks. Any reference to a “Class” view is not intended to be limiting, but is intended as exemplary for the type of view provided to a display by a particular camera.

Each camera arm 16A-16B may also provide a housing that encloses electronics, e.g., a controller, that are configured to provide various features of the CMS 15, and/or one or more object detection sensors (e.g., ultrasonic, radar, or lidar). The camera arms 16A-B may be mounted either at a roof-mount location over the cab door (as shown), or on a door-mounted bracket or station, for example.

If video of Class V and Class VI views are also desired, a camera housing 16C and camera 20C may be arranged at or near the front of the commercial vehicle 10 to provide those views (FIG. 2).

A backup camera 20D may be provided which provides a field of view FOVEX3. The backup camera 20D may be mounted at a top/centerline of the trailer, at a bumper/bed level of the trailer, or at a top-corner of the back of the trailer, for example. Alternatively, or in addition to the rear trailer camera, a “fifth wheel camera” 20E may be provided that is mounted to a rear of the tractor 12 and that provides a field of view FOVEx4. The fifth wheel camera 20E may be mounted anywhere between the lateral plane of the fifth wheel fixture and the top/roof edge of the tractor, for example.

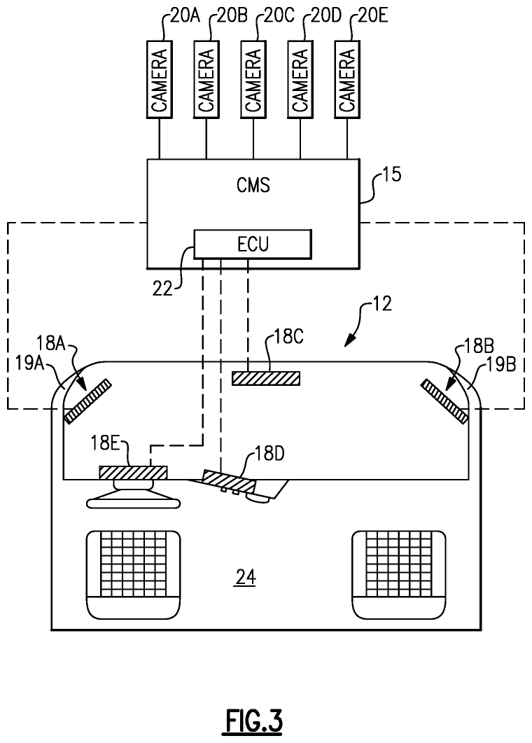

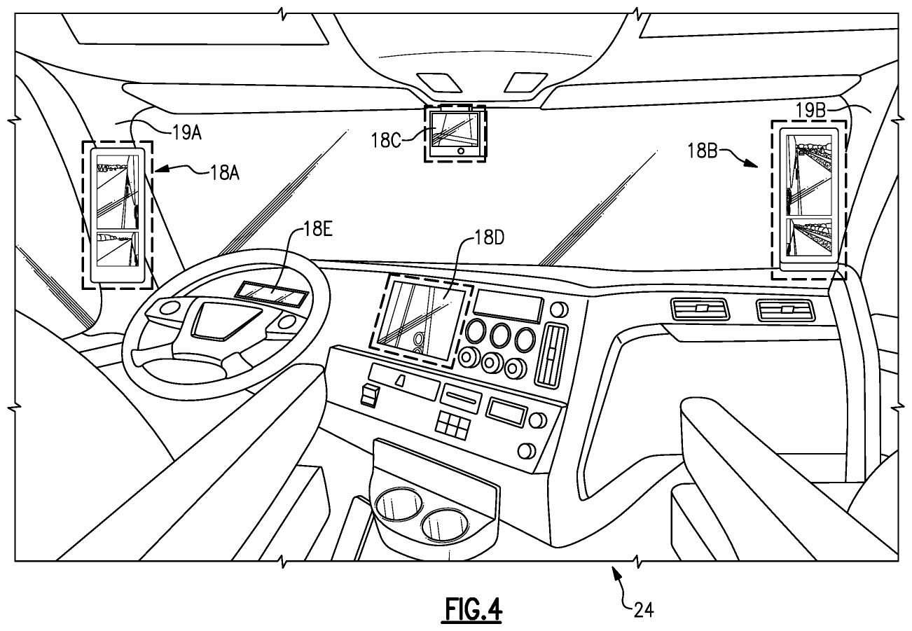

FIG. 3 is a schematic top view of an example vehicle cabin 24, and FIG. 4 is a perspective view of the vehicle cabin 24. Referring now to FIGS. 3-4 with continued reference to FIGS. 1-2, electronic displays 18A-E (e.g., which may be video displays, such as LCD displays) and cameras 20A-E are shown. A camera monitor system (CMS) 15 includes the camera arms 16A-B mounted to the outside of the vehicle cab 12 (FIG. 1), at least cameras 20A-B, and at least electronic displays 18A-B are part of a camera monitor system (CMS) 15. The displays 18C-E and cameras 20C-E may be part of the CMS 15 or may be part of a native vehicle camera system that is separate from the CMS 15.

The CMS 15 includes a CMS electronic control unit (ECU) 22 that includes processing circuitry that supports operation of the CMS 15 and is operatively connected to memory (which may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The processing circuitry may include one or more microprocessors, microcontrollers, application specific integrated circuits (ASICs), or the like.

The electronic displays 18A-B are arranged on each of the driver and passenger sides within the vehicle cab 12 on or near the A-pillars 19A-B to display Class II and Class IV views on its respective side of the commercial vehicle 10, which provide rear facing side views along the commercial vehicle 10 that are captured by the exterior cameras 20A-B.

As discussed above, if video of Class V and Class VI views are also desired, the camera housing 16C and camera 20C may be arranged at or near the front of the commercial vehicle 10 to provide those views (FIG. 2). In the example of FIG. 3, additional displays 18C-E are provided. Display 18C is arranged within the cab 12 near the top center of the windshield may be used to display the Class V and Class VI views, which are toward the front of the commercial vehicle 10, or a backup camera view (from camera 20D or 20E) to the driver. Display 18D is provided in a center console area of the cabin 24, and may be used for other purposes, such as navigation, infotainment, etc. Display 18E may be part of an instrument cluster, for example.

If video of Class VIII views is desired, camera housings can be disposed at the sides and rear of the commercial vehicle 10 to provide fields of view including some or all of the Class VIII zones of the commercial vehicle 10. In such examples, one of the displays 18C-E may include one or more frames displaying the Class VIII views. The displays 18A, 18B, 18C face a driver region within the cabin 24 where an operator is seated on a driver seat.

If desired, the camera arms 16A-B may include conventional mirrors integrated with them as well, although the CMS 15 may be used to entirely replace mirrors. In additional examples, each side can include multiple camera arms, each arm housing one or more cameras and/or mirrors.

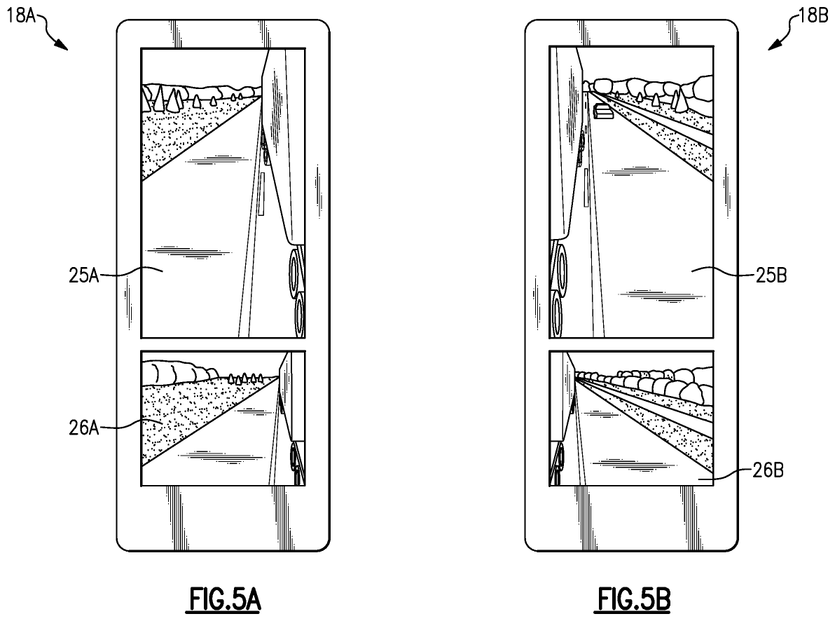

FIG. 5A is a schematic view of the electronic display 18A from FIGS. 1-4, and FIG. 5B is a schematic view of the electronic display 18B from FIGS. 1-4. Each display 18A-B includes a respective first display area 25A-B and a respective second display area 26A-B. In the example of FIGS. 5A-B, display area 25A is configured to display a Class II view from camera 16A, and display area 26A is configured to display a Class IV view from camera 16A (or an additional, wide angle camera situated on the same side of the commercial vehicle as camera 16A). Similarly, display area 25B is configured to display a Class II view from camera 16B, and display area 26B is configured to display a Class IV view from camera 16B (or an additional, wide angle camera situated on the same side of the commercial vehicle as camera 16B).

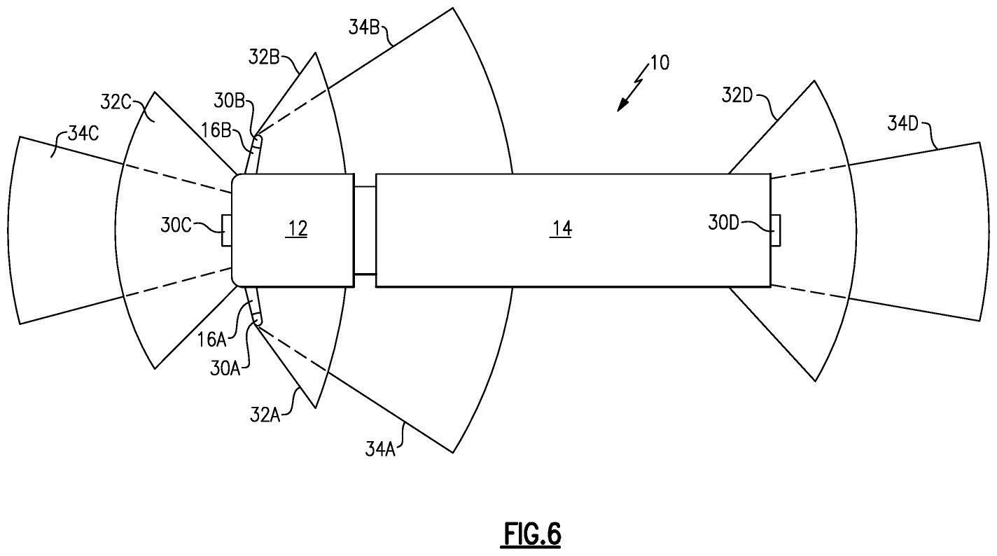

FIG. 6 is a schematic view of example object detection sensors 30A-D, having associated example object detection areas 32A-E and 34A-D. The object detection sensors 32 may include ultrasonic, radar, or lidar sensors, for example. In the example of FIG. 6, each object detection sensor 30A-D is depicted as having two potential associated detection areas 32 and 34, with 32 being short range, and 34 being long range. In one or more embodiments, each detection sensor 30A-D includes a pair of object detection sensors, one of which (e.g., ultrasonic) provides the shorter range 32, and one of which (e.g., radar or lidar) provides the longer range 34. As shown in FIG. 6, object detection sensors 32A-B, which are separate from the cameras 20A-B, may be provided in the camera arms 16A-B.

Each object detection sensor 30 has an associated warning threshold corresponding to when a warning is provided to a driver of the commercial vehicle 10, and for some or all of the object detection sensors 30, that threshold can be adjusted to raise or lower the standard for when a warning provides. Lowering the warning threshold for one of the object detection sensors 30 corresponds to making it more likely that a warning will be provided (e.g., raising the distance within which a warning provided so that a warning is provided for an object detected within 20 feet of the commercial vehicle 10 instead of within 10 feet of the commercial vehicle 10). Conversely, raising the warning threshold for one of the object detection sensors 32 corresponds to making it less likely that a warning will be provided (e.g., lowering the distance within which a warning provided so that a warning is provided for an object detected within 5 feet of the commercial vehicle 10 instead of within 10 feet of the commercial vehicle 10).

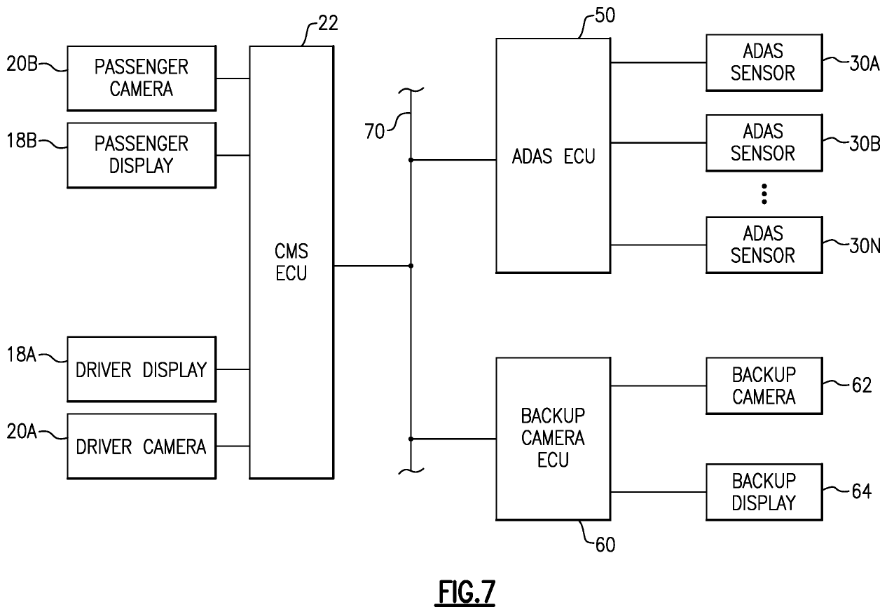

FIG. 7 is a schematic view of various CMS and advanced driver-assistance system (ADAS) elements that may be used for the commercial vehicle 10 of FIG. 1. As shown, the CMS ECU 22 is in communication with displays 18A-B and cameras 20A-B (for simplicity displays 18C-E and cameras 20C-E are not shown, but it is understood that they too could be in communication with the CMS ECU 22 as depicted in FIG. 3). An ADAS ECU 50 is in communication with ADAS sensors 30A-N. In one example, this includes ADAS sensors 30A-D of FIG. 6, and optionally also additional ADAS sensors located in the camera arms 16A (alternatively those additional ADAS sensors may be controlled by the CMS ECU 22). A backup camera ECU 60 is on communication with a backup camera 62 (e.g., cameras 20D and/or 20E) and a backup display 64 (e.g., display 18C, 18D, or 18E). The CMS ECU 22, ADAS ECU 50, and backup camera ECU 60 communicate with each other (in the non-limiting example of FIG. 7, over a communication bus 70, which may be a CAN bus). Although three separate ECUs 22, 50, 60 are shown, it is understood that one or more of them may be combined (e.g., such that the CMS ECU 22 is in direct communication with backup camera 62 and/or backup display 64 and controls when a backup camera image feed is displayed in the vehicle cabin 24).

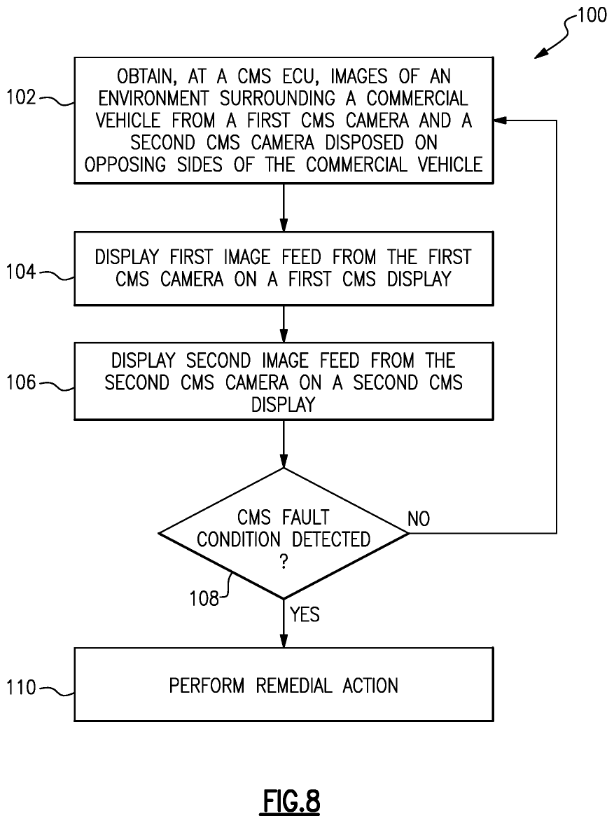

FIG. 8 is a flowchart of an example method 100 for a CMS 15. The CMS ECU 22 obtains images of an environment surrounding a commercial vehicle (e.g., Class II and/or Class IV views) from a first CMS camera 20A and a second CMS camera 20B, wherein the first CMS camera and the second CMS camera are disposed on opposing sides of commercial vehicle 10 (step 102).

The CMS ECU 22 displays a first image feed from the first CMS camera 20A on first CMS display 18A (step 104), and displays displaying a second image feed from the second CMS camera 20B on second CMS display 18B that is separate from the first CMS display 18A (step 106). Although camera 20A is referred to as the “first” CMS camera providing a “first” image feed and camera 20B is referred to as the “second” CMS camera providing a “second” image feed in the discussion below, it is understood that instead camera 20B and its feed could be the “first” and camera 20A and its feed could be the “second.”

The CMS ECU 22 determines whether the CMS 15 is experiencing a fault condition (step 108). If the CMS 15 is not experiencing a fault condition (a “no” to step 108), the method 100 proceeds back to step 102. However, if the CMS ECU 22 is experiencing the fault condition (a “yes” to step 108), a remedial action is performed (step 110).

In one or more embodiments, the fault condition is the CMS ECU 22 cannot receive (e.g., stops receiving) an image feed from one of the CMS cameras 20A-B. This fault condition could be due to a malfunction in which the one of the cameras 20A-B is not recording or outputting images, or could be a malfunction in a respective communication link between one of the cameras 20A-B and the CMS ECU 22. Assume, for the discussion below, that the CMS ECU 22 stops receiving the first image feed from the first CMS camera 20A. It is understood, however, that this could alternatively be the CMS ECU stopping receiving the second image feed from the second CMS camera 20B.

The remedial action performed in step 110 based on this fault condition may include:
A) replacing the first image feed on the first CMS display 18A with an image feed from backup camera 20D or 20E that is separate from the first CMS camera 20A and the second CMS camera 20B;
B) displaying an image feed from backup camera 20D or 20E on backup camera display (e.g., display 18C, 18D, or 18E) while the commercial vehicle 10 is moving forward (i.e., when the vehicle is in “drive” and is being driven forward), wherein the backup camera display is separate from the first CMS display 18A and the second CMS display 18B; or
C) adjusting a warning threshold for one at least one object detection sensor 30, which comprises a radar sensor, lidar sensor, and/or ultrasonic sensor.

In scenario A, the rear backup camera could be provided in display area 25 or 26 of display 18A, for example.

In scenario B, an image feed from backup camera 62 is displayed on one of a backup camera display, such as one of the displays 18C-E. Backup camera feeds are typically only displayed when a vehicle is parked or moving backwards. In this scenario, the backup camera 62 feed could also be used when the commercial vehicle 10 is moving forward, for example.

In scenario C, the warning threshold of one of the object detection sensors 30 is adjusted (e.g., “lowered” to make it more likely that a warning is provided, as described above). In one or more embodiments, the warning threshold is adjusted based on where the fault condition impacts the CMS 15 (e.g., if images cannot be displayed from camera 20A on display 18A, adjust warning threshold for object detection sensor 30A but not for object detection sensor 30B).

In one or more embodiments, the fault condition is that one of the CMS displays 18A-B cannot display its respective image feed. This fault condition could be due to a malfunction in which the one of the displays 18A-B is not recording or outputting images, or could be a malfunction in a respective communication link between one of the displays 18A-B and the CMS ECU 22. Assume, for the discussion below, that the CMS ECU 22 cannot display the first image feed on the first CMS display 18. It is understood, however, that this could alternatively be the CMS ECU 22 cannot display the second image feed on the second CMS display 18B.

The remedial action performed in step 110 based on this fault condition may include:
A) initiating display of the first image feed on the display 18B; or
B) initiating display of the first image feed on a third display that is separate from the CMS displays 18A-B.

In scenario A, the first image feed could be displayed in display area 26B while the second image feed continues to be displayed in display area 25B of the CMS display 18B (or vice versa). In this manner, CMS display 18B could display both the first and second image feeds simultaneously on the separate display areas 25B, 26B of electronic display 18B.

In scenario C, the first image feed could be displayed on one of the displays 18C-E.

In one or more embodiments, the fault condition is the CMS ECU 22 is malfunctioning. This may be detected, for example, by communication ceasing between the CMS ECU 22 and one or both of the ADAS ECU 50 and backup camera ECU 60, when there is some expected communication that should be received (e.g., a periodic handshake, packet exchange, etc.). The lack of an update or response from the CMS ECU 22 may be interpreted as the CMS ECU 22 malfunctioning. In another example, the malfunction may be detected by the ECU 22 transmitting a notification (e.g., flag or diagnostic code) to the ADAS ECU 50 or backup camera ECU 60.

The remedial action performed in step 110 based on this fault condition may include:
A) displaying the image feed from the backup camera 62 on the backup camera display 64 while the commercial vehicle 10 is moving forward; and/or
B) adjusting a warning threshold for one or more of the object detection sensors 30A-N (as discussed above).

The various techniques discussed herein provide a variety of ways of addressing CMS fault conditions within the CMS 15, or both within and outside of the CMS 15 (e.g., in examples where the CMS ECU 22 relies on the ADAS ECU 50 and/or backup camera ECU 60, which may be native to the vehicle and be outside of the CMS 15, to help perform the remedial action.

In one or more embodiments, the CMS may also be used to help identify fault conditions detected in the ADAS ECU 50 and/or backup camera ECU 60. For example, if one of the displays 18C-E failed (e.g., the display itself failed or a communication link to the display failed), the information that would otherwise have been displayed on that failed display may be displayed on one of the other displays (e.g., display 18A and/or 18B). This may result in a backup camera 62 image feed being provided on display 18A or 18B (or 18D or 18E), or instrument cluster information intended for display on display 18E being instead displayed on display 18A or 18B (or 18D or 18E).

In one or more embodiments, the various remedial actions discussed above for addressing CMS fault conditions in connection with FIG. 8 are meant as temporary, short-term solutions until a commercial vehicle can safely stop (e.g., pulling over onto the side of the road), and are not meant as long-term solutions.

Although example embodiments have been disclosed, a worker of ordinary skill in this art would recognize that certain modifications would come within the scope of the claims. For that reason, the following claims should be studied to determine their true scope and content.

What is claimed is:

1. A method for a camera monitor system (CMS), comprising:
obtaining, at a CMS electronic control unit (ECU), images of an environment surrounding a commercial vehicle from a first CMS camera and a second CMS camera, wherein the first CMS camera and the second CMS camera are disposed on opposing sides of the commercial vehicle;
displaying a first image feed from the first CMS camera on a first CMS display;
displaying a second image feed from the second CMS camera on a second CMS display that is separate from the first CMS display; and
based on detection of a fault condition in which the CMS ECU stops receiving the first image feed from the first CMS camera, performing a remedial action, wherein the remedial action comprises:
replacing the first image feed on the first CMS display with an image feed from a backup camera that is separate from the first CMS camera and the second CMS camera;
displaying an image feed from the backup camera on a backup camera display while the commercial vehicle is moving forward, wherein the backup camera display is separate from the first CMS display and the second CMS display; or
adjusting a warning threshold for at least one object detection sensor, which comprises a radar sensor, lidar sensor, or ultrasonic sensor.

2. The method of claim 1, wherein the remedial action comprises replacing the first image feed on the first CMS display with the image feed from the backup camera.

3. The method of claim 1, wherein the remedial action comprises displaying the image feed from the backup camera on the backup camera display while the commercial vehicle is moving forward.

4. The method of claim 1, wherein the remedial action comprises adjusting the warning threshold for the at least one object detection sensor.

5. A method for a camera monitor system (CMS), comprising:
obtaining, at a CMS electronic control unit (ECU), images of an environment surrounding a commercial vehicle from a first CMS camera and a second CMS camera, wherein the first CMS camera and second CMS camera are disposed on opposing sides of the commercial vehicle;
displaying a first image feed from the first CMS camera on a first CMS display;
displaying a second image feed from the second CMS camera on a second CMS display that is separate from the first CMS display; and
based on detection of a fault condition in which the first CMS display cannot display the first image feed, initiating display of the first image feed on the second CMS display or a third display that is separate from the first CMS display and the second CMS display.

6. The method of claim 5, said initiating display comprises initiating display of the first image feed on the third display.

7. The method of claim 6, wherein the third display is an instrument cluster display of the commercial vehicle or a backup camera display of the commercial vehicle.

8. The method of claim 5, wherein said initiating display of the first image feed comprises initiating display of the first image feed on the second CMS display, such that the second CMS display displays the first image feed and the second image feed.

9. A method for a camera monitor system (CMS), comprising:
obtaining, at a CMS electronic control unit (ECU), images of an environment surrounding a commercial vehicle from a first CMS camera and a second CMS camera, wherein the first CMS camera and second CMS camera are disposed on opposing sides of the commercial vehicle;
displaying a first image feed from the first CMS camera on a first CMS display;
displaying a second image feed from the second CMS camera on a second CMS display; and
based on detection of a fault condition of the CMS ECU, performing a remedial action, wherein the remedial action comprises:
displaying an image feed from a backup camera on a backup camera display while the commercial vehicle is moving forward, wherein the backup camera display is separate from the first CMS display and the second CMS display, and wherein the backup camera is separate from the first CMS camera and the second CMS camera; or
adjusting a warning threshold for at least one object detection sensor, which comprises a radar sensor, lidar sensor, or ultrasonic sensor.

10. The method of claim 9, wherein the remedial action comprises displaying the image feed from the backup camera on the backup camera display while the commercial vehicle is moving forward.

11. The method of claim 9, wherein the remedial action comprises adjusting a warning threshold for the at least one object detection sensor.

12. A camera monitor system (CMS), comprising:
a first CMS camera;
a second CMS camera;
a first CMS display;
a second CMS display; and
a CMS electronic control unit (ECU) configured to:
obtain a first image feed from the first CMS camera and obtain a second image feed from the second CMS camera, wherein the first image feed and second image feed depict an environment surrounding a commercial vehicle;
display the first image feed on the first CMS display and display the second image feed on the second CMS display; and
based on detection of a fault condition in which the CMS ECU stops receiving the first image feed from the first CMS camera, perform a remedial action, wherein the remedial action comprises:
replacement of the first image feed on the first CMS display with an image feed from a backup camera that is separate from the first CMS camera and the second CMS camera;
display of an image feed from the backup camera on a backup camera display while the commercial vehicle is moving forward, wherein the backup camera display is separate from the first CMS display and the second CMS display; or
adjustment of a warning threshold for at least one object detection sensor, which comprises a radar sensor, lidar sensor, or ultrasonic sensor.

13. The CMS of claim 12, wherein the remedial action comprises replacement of the first image feed on the first CMS display with the image feed from the backup camera.

14. The CMS of claim 12, wherein the remedial action comprises display of the image feed from the backup camera on the backup camera display while the commercial vehicle is moving forward.

15. The CMS of claim 12, wherein the remedial action comprises adjustment of the warning threshold for the at least one object detection sensor.

16. A camera monitor system (CMS), comprising:
a first CMS camera;
a second CMS camera;
a first CMS display;
a second CMS display; and
a CMS electronic control unit (ECU) configured to:
obtain images of an environment surrounding a commercial vehicle from the first CMS camera and the second CMS camera, wherein the first CMS camera and second CMS camera are disposed on opposing sides of the commercial vehicle;
display a first image feed from the first CMS camera on the first CMS display;
display a second image feed from the second CMS camera on the second CMS display; and
based on detection of a fault condition in which the first CMS display cannot display the first image feed, initiate display of the first image feed on the second CMS display or on a third display that is separate from the first CMS display and the second CMS display.

17. The CMS of claim 16, wherein the CMS ECU is configured to, based on detection of the fault condition of the first display, initiate display of the first image feed on the third display.

18. The CMS of claim 17, wherein the third display is an instrument cluster display of the commercial vehicle or a backup camera display of the commercial vehicle.

19. The CMS of claim 16, wherein the CMS ECU is configured to, based on detection of the fault condition of the first display, initiate display of the first image feed on the second CMS display, such that the second CMS display displays the first image feed and the second image feed.

20. A camera monitor system (CMS), comprising:
a first CMS camera;
a second CMS camera;
a first CMS display;
a second CMS display; and
a CMS electronic control unit (ECU) configured to:
obtain images of an environment surrounding a commercial vehicle from the first CMS camera and the second CMS camera, wherein the first CMS camera and second CMS camera are disposed on opposing sides of the commercial vehicle;
display a first image feed from the first CMS camera on the first CMS display;
display a second image feed from the second CMS camera on the second CMS display; and
based on detection of a fault condition of the CMS ECU, perform a remedial action, wherein the remedial action comprises:
display of an image feed from a backup camera on a backup camera display while the commercial vehicle is moving forward, wherein the backup camera display is separate from the first CMS display and the second CMS display, and wherein the backup camera is separate from the first CMS camera and the second CMS camera; or
adjustment of a warning threshold for at least one object detection sensor, which comprises a radar sensor, lidar sensor, or ultrasonic sensor.

21. The CMS of claim 20, wherein the remedial action comprises display of the image feed from the backup camera on the backup camera display while the commercial vehicle is moving forward.

22. The CMS of claim 20, wherein the remedial action comprises adjustment of the warning threshold for the at least one object detection sensor.
